(19) United States
(12) Patent Application Publication
(10) Pub. No.: US 2021/0187744 A1
(43) Pub. Date: Jun. 24, 2021

(54) SPACE MONITORING ROBOT BY 360-DEGREE IMAGE PHOTOGRAPHING FOR SPACE

(71) Applicant: VARRAM SYSTEM CO., LTD., Yuseong-gu (KR)

(72) Inventors: Byung Jo SUH, Yuseong-gu (KR); Kyoung Seok KIM, Yuseong-gu (KR)

(21) Appl. No.: 16/727,470

(22) Filed: Dec. 26, 2019

(30) Foreign Application Priority Data
Dec. 20, 2019 (KR) 10-2019-0171730

(51) Int. Cl. B25J 9/16; B25J 13/08

(52) U.S. Cl. CPC B25J 9/1679; B25J 9/1694; B25J 9/1664; B25J 9/161; B25J 13/08

(57) ABSTRACT

A space monitoring robot by 360-degree image photographing for a space includes: a camera obtaining a 360-degree image; a sensor unit sensing an obstacle; a moving means moving the space monitoring robot; and a processor extracting and analyzing information on an omni-directional space using the image obtained through the camera and confirming abnormality of a space and a target.

### BACKGROUND

### Field

The present disclosure relates to a space monitoring robot by 360-degree image photographing for a space, and more particularly, to a space monitoring robot by 360-degree image photographing for a space capable of recognizing or monitoring a space or caring for a care target through a processor capable of allowing a moving robot to simultaneously monitor various spaces such as a home or an office at 360 degrees.

### Description of the Related Art

Recently, various monitoring robots have been developed. A market of a telepresence robot, which is a representative product among them, has been rapidly developed, and with the addition of mobility of a mobile monitoring robot, it is expected that the market will be expanded to roles of communication and collaboration in consumer market fields such as a home, a company, an education, a healthcare, and a security.

Representative application markets of the monitoring robots are a smart home, a medical field, a business management, a retail, a facility management and operation, a smart factory, and the like. With the development of a high speed Internet network and a 4th generation (4G) long term evolution (LTE) mobile communication network, the monitoring robot is provided in a form in which the robot and communication are integrated with each other to allow a user to remotely control the robot or allow the user to look around or talk with the other party as if the user is actually there while the robot moves by oneself.

In 2017,Silicon Valley OhmniLabs of U.S. has officially announced a home telepresence “Ohmni robot” capable of performing video chatting, and the “Ohmni robot” has got a pre-investment of approximately $150,000 through Indiegogo crowd funding.

In a situation where the Internet of Things, a smart robot, a virtual reality, and an artificial intelligence become issues as the era of the fourth industrial revolution began as described above, it is expected that a technology of overcoming a limitation in a space through a robot that may monitor a remote space will be explosively grown.

### SUMMARY

The present disclosure is provided in order to solve the problem described above, and it is most important in the present disclosure to develop a robot capable of opening a new market of space monitoring by overcoming a limitation in a sight line of an existing monitoring robot and reducing a cost as compared with a telepresence robot.

An existing home monitoring robot monitors a space at a fixed field of view, and a blind spot is thus present, but a robot developed in the present disclosure may monitor a space at 360 degrees, and various spaces may thus be monitored in real time.

The existing robot should have a pat/tilt structure in order to monitor the space in all directions without the blind spot. However, in a monitoring robot having a high sight line, such a pat/tilt structure hinders driving stability, and makes a structure complicated.

Therefore, in the present disclosure, images input through a plurality of lenses may be processed and be combined into one image to monitor all spaces in real time. The monitoring robot mounted with such a 360-degree omni-directional camera may confirm a stored image by a past time line function, and may thus monitor all spaces where the robot is positioned, without the blind spot.

In addition, the monitoring robot includes a high performance microphone and a high-quality speaker mounted for the purpose a two-way conversation, and includes a noise removal and one-way focused conversation function and a conversation function capable of removing a background noise and a discursive sound.

In addition, the monitoring robot includes a laser distance measuring sensor capable of measuring a distance between a camera and an object and an autonomous driving function through which the robot may move by oneself through camera image recognition in order to recognize an obstacle and perform autonomous driving.

The monitoring robot includes a function capable of performing an intelligent space security and monitoring task beyond a limitation of the existing monitoring robot and actively monitoring a target as IOT devices interwork with such an autonomous driving function and a speech recognition technology.

The most important portion in the monitoring robot is to implement a technology of combining images collected from two or more cameras by a function capable of monitoring the space at 360 degrees to monitor the space by a 360-degree omni-directional monitoring camera function or analyze a moving path of a care or monitoring target and follow the target.

Since the monitoring robot is developed in a form in which it may perform autonomous driving unlike the existing robot, the monitoring robot does not function only in a state where a person access the monitoring robot, but may perform a monitoring task at any time and space input by a user. The monitoring robot includes an obstacle recognition and mapping algorithm in order to perform such autonomous driving, and includes a mapping correction algorithm through a complex technology of a gyro sensor, an encoder sensor and a camera sensor.

The monitoring robot may perform various services through the 360-degree omni-directional monitoring and the autonomous driving function, includes a function of notifying the user of insufficiency of power of a battery when power of the battery is low in a service performing process, and includes an automatic charging function of finding a charger by oneself and automatically charging the battery when the power of the battery drops to a specific level or less.

Since the monitoring robot is driven in a space in which the care target is present, it is very important to secure stability in driving the monitoring robot. Therefore, the monitoring robot includes a shock absorbing device and a shock sensing device for preventing the monitoring robot from being overturned or damaged when the robot passes through or collides with an obstacle.

In addition, since the monitoring robot includes a situation recognition speed control algorithm of deciding a surrounding situation through a distance sensor capable of sensing a surrounding obstacle and stably maintaining a speed of the monitoring robot oneself even though a consumer controls the monitoring robot at the highest speed in a case where there are many obstacle, the monitoring robot may be stably driven in a complicated space and may be rapidly driven in a situation in which there is no obstacle.

A representative service development content through image processing in the monitoring robot includes a tracking algorithm for the target, and includes an emergency notification service of analyzing the moving path of the target and generating data on the moving path of the target to confirm a movement amount or an abnormal state of the target.

In addition, the monitoring robot includes a security function in which the monitoring robot moves by oneself to confirm a state and transmits an image, in a case where an intruder is sensed in the monitoring space by a separate intruder sensor that interworks with the monitoring robot.

In addition, the monitoring robot includes a departure notification technology capable of confirming a departure of the target by transmitting a notification to a registered terminal when the target moves to a movement prohibition region set by the user on the basis of a position or the target is out of a field of view of the monitoring robot.

According to an exemplary embodiment of the present disclosure, a space monitoring robot by 360-degree image photographing for a space includes: a camera obtaining a 360-degree image; a sensor unit sensing an obstacle; a moving means moving the space monitoring robot; and a processor extracting and analyzing information on an omni-directional space using the image obtained through the camera and confirming abnormality of a space and a target.

The processor may control the moving means so that the space monitoring robot moves to a specific zone in order to care for the space and the target.

The processor may analyze a moving path of the target through a 360-degree omni-directional image obtained through the camera.

The processor may transmit the obtained image to a server and a user terminal, and transmit an abnormal state related message to the user terminal and a manager terminal when an abnormal state of the space and the target is confirmed.

### BRIEF DESCRIPTION OF THE DRAWINGS

FIGS. 1 and 2 are views for describing a space monitoring robot by 360-degree image photographing for a space according to an exemplary embodiment of the present disclosure.

FIG. 3 is a block diagram for describing the space monitoring robot by 360-degree image photographing for a space according to an exemplary embodiment of the present disclosure.

FIG. 4 is a flowchart for describing a process of driving the space monitoring robot by 360-degree image photographing for a space.

### DETAILED DESCRIPTION

Hereinafter, detailed contents for embodying the present disclosure will be described in detail with reference to the accompanying drawings.

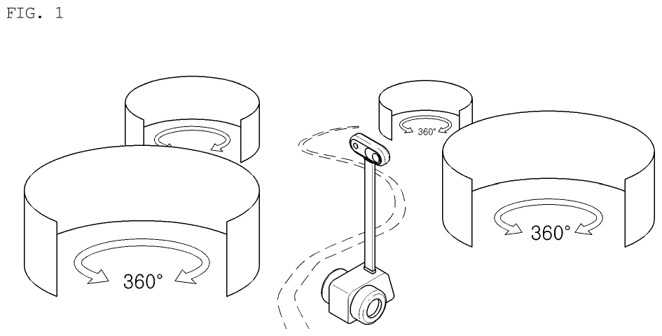

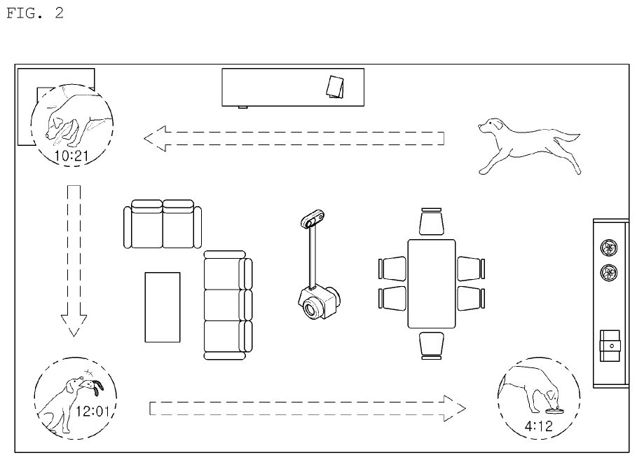

FIGS. 1 and 2 are views for describing a space monitoring robot by 360-degree image photographing for a space according to an exemplary embodiment of the present disclosure.

Referring to FIGS. 1 and 2, a moving means may be a means for moving a body of a robot. For example, the moving means may include a component such as a wheel.

A camera may obtain an image at 360 degrees. For example, the camera may obtain an image at 360 degrees while rotating through a driving unit, or may obtain an image at 360 degrees by combining images obtained from two or more cameras with each other in real time.

A control unit may control components included in a mobile space monitoring robot.

The control unit may extract and analyze information on an omni-directional space using the image obtained through the camera.

The present disclosure may monitor a space at a time through an omni-directional camera unlike an existing monitoring robot, in monitoring the space while moving in the space through a monitoring robot that may move by oneself in the space.

In this case, when the robot only moves in the space, the camera continuously collects images in all directions, and transmits these images to a server. Therefore, the user may access the server at any time to again confirm the images of the space in all directions or confirm the images of the space in real time.

In addition, the present disclosure may continuously check a moving path of a target. In the related art, the robot should be continuously driven in order to perform such a function, but in the present disclosure, a target may be continuously monitored without driving the robot.

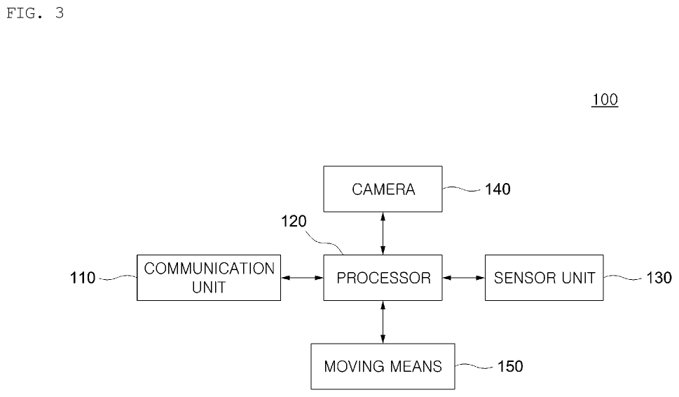

FIG. 3 is a block diagram for describing the space monitoring robot by 360-degree image photographing for a space according to an exemplary embodiment of the present disclosure.

Referring to FIG. 3, the space monitoring robot 100 by 360-degree image photographing for a space may include a communication unit 110, a processor 120, a position sensor 130, a camera 140, and a moving means 150.

The communication unit 110 may perform communication with various types of external devices in various wired or wireless manners under the control of the processor 120. For example, the communication unit 110 may perform communication with various servers through a network such as the Internet.

The position sensor 130 may sense an obstacle, and sense a position of the robot. For example, the position sensor 130 may include various sensors such as an infrared sensor, an ultraviolet sensor, and a global positioning system (GPS) sensor.

The camera 140 photographs a 360-degree external image under the control of the processor 120. Particularly, the camera 140 may photograph a 360-degree surrounding image during a period in which the space monitoring robot 100 by 360-degree image photographing for a space moves. The image data photographed as described above may be provided to the processor 120.

The moving means 150 may move the space monitoring robot 100 by 360-degree image photographing for a space. For example, the moving means 150 may include a means that may rotate, such as a wheel.

The processor 120 controls a general operation of the space monitoring robot by 360-degree image photographing for a space.

The processor 120 constructs a space map, and maps a position of a charging unit.

The processor 120 obtains a 360-degree omni-directional image.

The processor 120 performs robot autonomous driving, and senses an obstacle or a target.

The processor 120 moves to a specific zone in order to care for the space and the target.

The processor 120 analyzes a moving path of the target through the 360-degree omni-directional image.

The processor 120 transmits the obtained image to a server and a user terminal.

The processor 120 confirms an abnormal state of the space and the target.

The processor 120 notifies the user terminal, a manager terminal, and the like, of the abnormal state when the abnormal state is confirmed.

A storing unit (not illustrated) stores service space map data, and stores various programs and data for an operation of the space monitoring robot 100 by 360-degree image photographing for a space.

A charging unit (not illustrated) is separately provided to interwork with the robot so that the robot may dock with the charging unit by oneself, and may charge the robot.

The space monitoring robot 100 by 360-degree image photographing for a space further includes an IoT based wearable sensor worn by a care target (a person, an animal, or the like). The wearable sensor may recognize an abnormal state of the care target and transmit data on the abnormal state of the care target to the home robot 100. The home robot 100 may move an abnormal state generation zone on the basis of the data transmitted from the wearable sensor, photograph a state of the target, and transmit the photographed data.

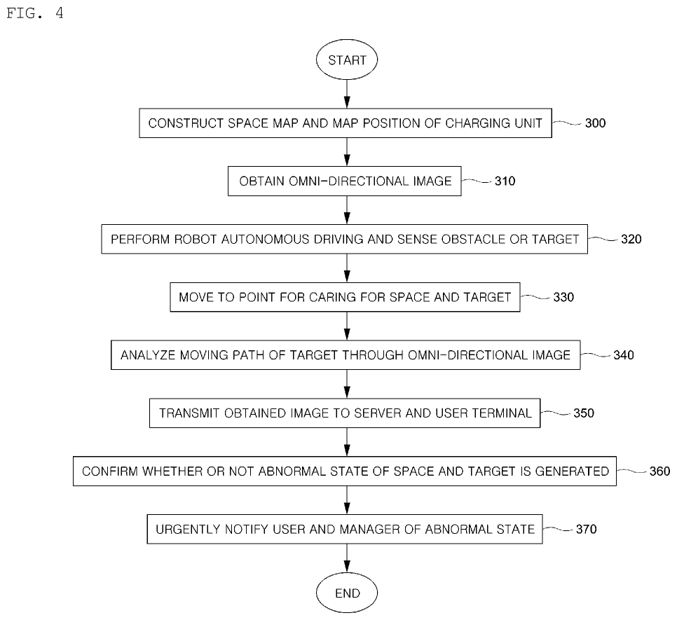

FIG. 4 is a flowchart for describing a process of driving the space monitoring robot by 360-degree image photographing for a space.

Referring to FIG. 4, the space monitoring robot by 360-degree image photographing for a space constructs a space map, and maps a position of the charging unit (300).

The space monitoring robot by 360-degree image photographing for a space obtains a 360-degree omni-directional image (310).

The space monitoring robot by 360-degree image photographing for a space performs robot autonomous driving, and senses an obstacle or a target (320).

The space monitoring robot by 360-degree image photographing for a space moves to a specific zone in order to care for the space and the target (330).

The space monitoring robot by 360-degree image photographing for a space analyzes a moving path of the target through the 360-degree omni-directional image (340).

The space monitoring robot by 360-degree image photographing for a space transmits the obtained image to a server and a user terminal (350).

The space monitoring robot by 360-degree image photographing for a space confirms an abnormal state of the space and the target (360).

The space monitoring robot by 360-degree image photographing for a space transmits the abnormal state to the user terminal, a manager terminal, and the like, (or notifies the user terminal, a manager terminal, and the like, of the abnormal state) when the abnormal state is confirmed (370). Therefore, a protector and a manager may grasp a situation in real time.

According to the present disclosure, target care and intruder monitoring in a monitoring space may be performed through a function of monitoring the monitoring space at 360 degrees, and when a situation occurs, a monitoring robot may primarily cope with the situation by oneself, such that a burden of a manager may be reduced. In addition, all contents of the monitoring space at a point in time when the situation occurs may be stored, such that a situation monitoring service may be provided without a blind spot.

All or some of the respective exemplary embodiments may be selectively combined with each other so that the above-mentioned exemplary embodiments may be variously modified.

In addition, it is to be noted that the exemplary embodiments are provided in order to describe the present disclosure rather than limiting the present disclosure. Further, it may be understood by those skilled in the art to which the present disclosure pertains that various exemplary embodiments are possible without departing from the spirit and scope of the present disclosure.

What is claimed is:

1. A space monitoring robot by 360-degree image photographing for a space, comprising:
a camera obtaining a 360-degree image;
a sensor unit sensing an obstacle;
a moving means moving the space monitoring robot; and
a processor extracting and analyzing information on an omni-directional space using the image obtained through the camera and confirming abnormality of a space and a target.

2. The space monitoring robot by 360-degree image photographing for a space of claim 1, wherein the processor controls the moving means so that the space monitoring robot moves to a specific zone in order to care for the space and the target.

3. The space monitoring robot by 360-degree image photographing for a space of claim 1, wherein the processor analyzes a moving path of the target through a 360-degree omni-directional image obtained through the camera.

4. The space monitoring robot by 360-degree image photographing for a space of claim 1, wherein the processor transmits the obtained image to a server and a user terminal, and transmits an abnormal state related message to the user terminal and a manager terminal when an abnormal state of the space and the target is confirmed.
